(19) United States
(12) Patent Application Publication
(10) Pub. No.: US 2006/0293892 A1
(43) Pub. Date: Dec. 28, 2006

(54) Biometric control systems and associated methods of use

(76) Inventor: Jan Pathuel, Vaerloese (DK)

Correspondence Address: PERKINS COIE LLP;PATENT-SEA, P.O. BOX 1247, SEATTLE, WA, 98111-1247, US

(21) Appl. No.: 11/254,555

(22) Filed: Oct. 20, 2005

Related U.S. Application Data
(63) Continuation-in-part of application No. 11/159,814, filed on Jun. 22, 2005.
(60) Provisional application No. 60/693,371, filed on Jun. 22, 2005.

(51) Int. Cl. G10L 17/00

(52) U.S. Cl. 704/246

(57) ABSTRACT

Methods and systems are disclosed herein for controlling various types of vehicle systems and other systems with biometric input and/or other types of input. A method for controlling access to a vehicle in accordance with one embodiment of the invention includes receiving biometric input and positional input. The method further includes determining, based on the biometric input, if the source of the biometric is authorized to access the vehicle, and determining, based on the positional input, if the vehicle is in an acceptable location to allow access to the vehicle. The method additionally includes allowing access to the vehicle when, based on the biometric input, the source of the biometric input is authorized to access the vehicle, and when, based on the positional input, the vehicle is in an acceptable location to allow access to the vehicle.

### CROSS-REFERENCE TO RELATED APPLICATIONS INCORPORATED BY REFERENCE

The present application is a Continuation-In-Part of U.S. patent application Ser. No. 11/159,814, entitled “BIOMETRIC CONTROL SYSTEMS AND ASSOCIATED METHODS OF USE,” filed Jun. 22, 2005; the present application claims the benefit of U.S. Provisional Patent Application Ser. No. 60/693,371, entitled “BIOMETRIC CONTROL SYSTEMS AND ASSOCIATED METHODS OF USE,” filed Jun. 22, 2005; and the present application incorporates both of the aforementioned patent applications in their entireties by reference.

### TECHNICAL FIELD

The following disclosure relates generally to the field of biometrics and, more particularly, to methods and systems for using biometric input to control various types of electronic devices and systems.

### BACKGROUND

The science of biometrics concerns the reading of measurable, biological characteristics of an individual in order to identify the individual to a computer or other electronic system. Biological characteristics typically measured include fingerprints, voice patterns, retinal and iris scans, faces, and even the chemical composition of an individual's perspiration. For an effective “two-factor” security authorization of an individual to a computer system, normally a biometric measure is used in conjunction with a token (such as a smartcard) or an item of knowledge (such as a password).

The complexity of biometry centers on the necessity of gathering and deriving precise and consistent data from the biometric input. In many instances, it is not the gathering of data that presents a problem. Rather, it is the ability to accurately and reliably analyze and classify the data and, through this, score the data in a way that allows and maintains a desired level of security.

Speaker recognition is the generic term used for two related problems: speaker identification and speaker verification. With speaker identification, the problem is to determine the identity of an unknown speaker from a known group of (N) possible speakers. Hence, an N-way classification must be made, or N+1 if a “no decision” classification is allowed. Speaker verification is basically the same problem as speaker identification, except that a claimed identity is also given and the problem is “merely” to confirm or disconfirm the identity claim. A speaker who makes false identity claims is referred to as an impostor speaker. Speakers corresponding to correct identity claims are referred to as target speakers. It is characteristic for the two problems that speaker identification gets increasingly more difficult as the population size (N) grows, whereas the speaker verification problem is—in principle—independent of the population size.

The main application of speaker verification is for person authentication purposes as discussed above. Forensic speaker recognition is usually performed as a speaker identification experiment (a voice line up), but apart from this special application, speaker identification is mainly useful as a sub-component in a larger system and not mainly as an independent application. Although speaker verification and speaker identification are different applications, the underlying problems are basically the same, and it is usually relatively easy to convert a speaker verification system to a speaker identification system and vice versa.

Speaker recognition techniques do not necessarily rely on knowledge of the spoken text; the speech can be modeled “text independently.” In a text independent speaker recognition system, speakers are not required to speak specific utterances in order to be recognized. Speaker identification systems are usually of this kind. Knowledge of the text, however, allows a more detailed modeling, and is an advantage because the observed speech events can be modeled more accurately. In a text dependent speaker recognition system, speakers are required to speak specific password-like utterances. Text dependent speaker recognition systems cannot recognize speakers from arbitrary utterances; the speakers must utter one of the password utterances with which the system is familiar.

For speaker verification, it is in many situations vitally important that an “aliveness” (event level) test can be performed so that impostors who have managed to obtain recordings of a target speaker's voice may be rejected. This can be done by prompting the speakers to utter specific sentences, which they can not predict in advance. By verifying the text, it can be certified that the speech is not simply a prerecorded voice. This scenario is referred to as text prompted speaker verification.

A distinction is made between closed set and open set recognition. Closed set means that all the possible speakers are known in advance. Open set means that not all speakers may have been introduced. For speaker identification this distinction is critical, because if the speaker of a test utterance (the target speaker) has not been introduced, then the identification problem has no solution. A speaker verification system must always be able to handle out-of-set speakers, because impostors are likely to belong to this category.

A biometric system that utilizes more than one core technology for user authentication is referred to as multimodal (in contrast to monomodal). Many suggest that multimodal systems can offer more security for the enterprise and convenience for the end user. There are three types of multimodality in the biometric world: synchronous, asynchronous, and either/or.

Either/or multimodality describes systems that offer multiple biometric technologies, but only require verification through a single technology. For example, an authentication infrastructure might support facial, voice, and fingerprint at each desktop and allow users to verify through any of these methods. A number of vendors have developed enabling middleware that allows for authentication by means of various biometrics. The benefit of this system is that biometrics, instead of passwords, can be used as a fallback. To have access to either/or multimodality, a user must enrol in each technology. To use finger, face, and voice, for example, one must become familiar with three devices and three submission processes. As a key performance indicator in biometrics is ease-of-use, requiring familiarity with multiple processes can be problematic.

Asynchronous multimodality describes systems that require that a user verify through more than one biometric in sequence. Asynchronous multimodal solutions are comprised of one, two, or three distinct authentication processes. A typical user interaction will consist of verification on finger scan, then face if finger is successful. The advantage of added security—it is highly unlikely that a user will break two systems—is offset by a reduction in convenience. In addition to the time required to execute these separate submissions correctly (such verification can require 10 seconds of submission) the user must learn multiple biometric processes, as in either/or systems. This can be a challenge for both physical and logical access scenarios.

Synchronous multimodality involves the use of multiple biometric technologies in a single authentication process. For example, biometric systems exist which use face and voice simultaneously, reducing the likelihood of fraud and reducing the time needed to verify. Systems that offer synchronous multimodality can be difficult to learn, as one must interact with multiple technologies simultaneously.

A great deal of thought has gone into whether multiple biometrics are more or less accurate than a single biometric. This debate must take into account the fact that the process flow of enrolment and verification is as relevant to real-world performance as the underlying statistical bases for performance. It is rare that multiple biometric technologies will be used at a single authentication point (i.e. a door, a desktop) within an enterprise. It is likely, however, that various technologies will be deployed in suitable environments—voice for telephony-based verification, finger for PC-oriented verification, etc.

Biometric decision-making is comprised of various components and is frequently misunderstood. For the vast majority of technologies and systems, there is no such thing as a 100% match, though systems can provide a very high degree of certainty. In biometric decision-making, matching refers to the comparison of biometric templates to determine their degree of similarity or correlation. A match attempt results in a score that, in most systems, is compared against a threshold. If the score exceeds the threshold, the result is a match; if the score falls below the threshold, the result is a non-match.

### BRIEF DESCRIPTION OF THE DRAWINGS

FIG. 1 is a schematic diagram of a biometric control system configured in accordance with an embodiment of the invention.

FIG. 2 is a schematic diagram illustrating a suitable environment in which various embodiments of the present invention can be implemented.

FIG. 3 is a schematic diagram illustrating a method for controlling an electronic system in accordance with an embodiment of the invention.

FIG. 4 is a schematic diagram illustrating a method for controlling an electronic system in accordance with another embodiment of the invention.

FIG. 5 is flow diagram illustrating a two-part routine for enrolling an original biometric in a biometric verifier and verifying subsequent biometrics against the enrolled biometric.

FIG. 6 is flow diagram illustrating a routine for controlling an electronic system in accordance with an embodiment of the invention.

FIG. 7 is flow diagram illustrating a routine for controlling an electronic system in accordance with another embodiment of the invention.

FIG. 8 is a schematic diagram of a particular example of the routine described above with reference to FIG. 7.

FIG. 9 is a flow diagram illustrating a routine for remotely monitoring the location of a device in accordance with an embodiment of the invention.

FIGS. 10A-10E are a series of schematic diagrams illustrating various applications for embodiments of the invention.

FIG. 11 is a schematic diagram of a functional biometry model configured in accordance with an embodiment of the invention.

FIG. 12 is a schematic diagram of a biometric engine configured in accordance with an embodiment of the invention.

FIG. 13 is a partially schematic diagram of a vehicle having a biometric system configured in accordance with an embodiment of the invention.

### DETAILED DESCRIPTION

General Overview

The following disclosure is directed generally to methods for using voice, word, sound and/or other forms of biometric and non-biometric input to dynamically control various types of electronic devices and systems. The biometric technology described herein can be used to control a wide variety of electronic systems including, but not limited to, security systems, computer systems, communication systems, transportation systems, media systems, entertainment systems, appliance systems, etc. The various methods and systems described herein can be deployed as stand-alone, multifunctional biometric platforms, or as integrated parts of broader technology environments.

In contrast to conventional biometric control systems that control, for example, access to a device, system, or location in a static manner (i.e., based solely on biometric matching/non-matching criteria), embodiments of the present invention can be used to control access to a device, system, or location (and perform other functions) in a dynamic manner. “Dynamic” in this context refers to a control function that is performed based on biometric input and one or more external factors or dependencies that may change over time. For example, a conventional lap-top computer may include a fingerprint scanner for secure log-in. Once the user's fingerprint has been scanned and authenticated, the user is free to use the computer, regardless of any other considerations such as where the computer is located, what time of the day or week it is, what other devices and/or networks the computer is connected to, etc. In contrast to conventional systems, a computer (cell phone, building entrance, home appliance, or other device) configured in accordance with the present invention can include a biometric verifier and another component that checks one or more external dependencies before allowing access. These other dependencies can include, for example, time, location, atmospheric conditions, user condition, connectivity to other devices and/or networks, preset user preferences or limitations, etc. If the other dependencies are not satisfied, then access to the computer is denied, even if the fingerprint scanner verifies the requesting user. Or, if the external dependencies include preset preferences, limitations, or other features that correspond to the requesting user, then these features are implemented when access is provided.

Other embodiments of the present invention can be configured to respond to one or more non-biometric inputs. For example, as described in greater detail below, various types of electronic systems (e.g. computer systems, communication systems, transportation systems, home appliances, etc.) can be configured in accordance with the present invention to respond to changes in location (using, e.g., a GPS receiver) or changes in background noise. The changes in background noise can be caused by any number of different occurrences including, for example, changes in the weather, catastrophes (fire, accident, etc.), break-ins (broken glass, explosion, etc.), loud machinery, malfunctioning machinery, loud neighbors, etc.

Some biometric systems perform speaker or sound verification by comparing a reference template to a match template to determine their degree of similarity or correlation. Each comparison results in a score that, in most systems, is compared against a threshold. If the score exceeds the threshold, the result is a match; if the score falls below the threshold, the result is a non-match. While various embodiments of the present invention can utilize such systems for biometric verification, many of the methods and systems described herein are based on mathematical interpretation and analysis in monolithic and/or multilayered single or super classification models. Indeed, various embodiments of the present invention verify voice, word, sound and other biometric input using mathematical algorithms to accurately predict matches. As those of ordinary skill in the art will appreciate, aspects of the present invention are not limited to a particular method of voice, word, sound, or other biometric verification, but instead can be suitably implemented with any number of different biometric technologies.

The present disclosure further describes and distinguishes between static and dynamic technologies based on analysis and interpretation. Further, the disclosure exemplifies how various static and dynamic technologies become unified through a Multifunctional Biometric Interpretation Algorithm/Method (MBIA) in a dependency state via technical processes. The disclosure also discusses the functional derivatives of a dynamic process that by virtue of a computerized environment makes it possible for a user to control systems and/or adopt privileges based on a stand alone biometric process or a combination of biometric processes. Hence, in this context, static becomes dynamic by dependency. More specifically, the process is dynamic because interpretation of unknown biometric input (e.g., Vector X) results in output Y, which is a function of Vector X and/or one or more external dependencies. Such a process can be stated as a Biometric Interpretation Factor (BIF).

The present disclosure also describes various approaches for consolidating multiple biometric systems under one functional technology umbrella characterized by a scalable living environment. Likely users of such living biometry technology as disclosed herein may include microchip-dependent industries such as handheld device manufacturers, computer manufacturers, home appliance/media manufacturers, etc.

The following description provides specific details for a thorough understanding of various embodiments of the invention. One skilled in the art will understand, however, that the invention may be practiced without many of these details. Additionally, some well-known structures or functions may not be shown or described in detail, so as to avoid unnecessarily obscuring the relevant description of the various embodiments.

The terminology used in the description presented below is intended to be interpreted in its broadest reasonable manner, even though it is being used in conjunction with a detailed description of certain specific embodiments of the invention. Certain terms may even be emphasized below; however, any terminology intended to be interpreted in any restricted manner will be overtly and specifically defined as such in this Detailed Description section.

Although not required, aspects and embodiments of the present invention will be described in the general context of computer-executable instructions, such as routines executed by a general-purpose computer, e.g., a server or personal computer. Those skilled in the relevant art will appreciate that the invention can be practiced with other computer system configurations, including Internet appliances, hand-held devices, wearable computers, cellular or mobile phones, multi-processor systems, microprocessor-based or programmable consumer electronics, set-top boxes, network PCs, mini-computers, mainframe computers and the like. The invention can be embodied in a special purpose computer or data processor that is specifically programmed, configured or constructed to perform one or more of the computer-executable instructions explained in detail below. Indeed, the term “computer,” as used generally herein, refers to any of the above devices, as well as any data processor.

The invention can also be practiced in distributed computing environments, where tasks or modules are performed by remote processing devices, which are linked through a communications network, such as a Local Area Network (“LAN”), Wide Area Network (“WAN”) or the Internet. In a distributed computing environment, program modules or sub-routines may be located in both local and remote memory storage devices. Aspects of the invention described below may be stored or distributed on computer-readable media, including magnetic and optically readable and removable computer discs, stored as firmware in chips (e.g., EEPROM chips), as well as distributed electronically over the Internet or over other networks (including wireless networks). Those skilled in the relevant art will recognize that portions of the invention may reside on a server computer, while corresponding portions reside on a client computer. Data structures and transmission of data particular to aspects of the invention are also encompassed within the scope of the invention.

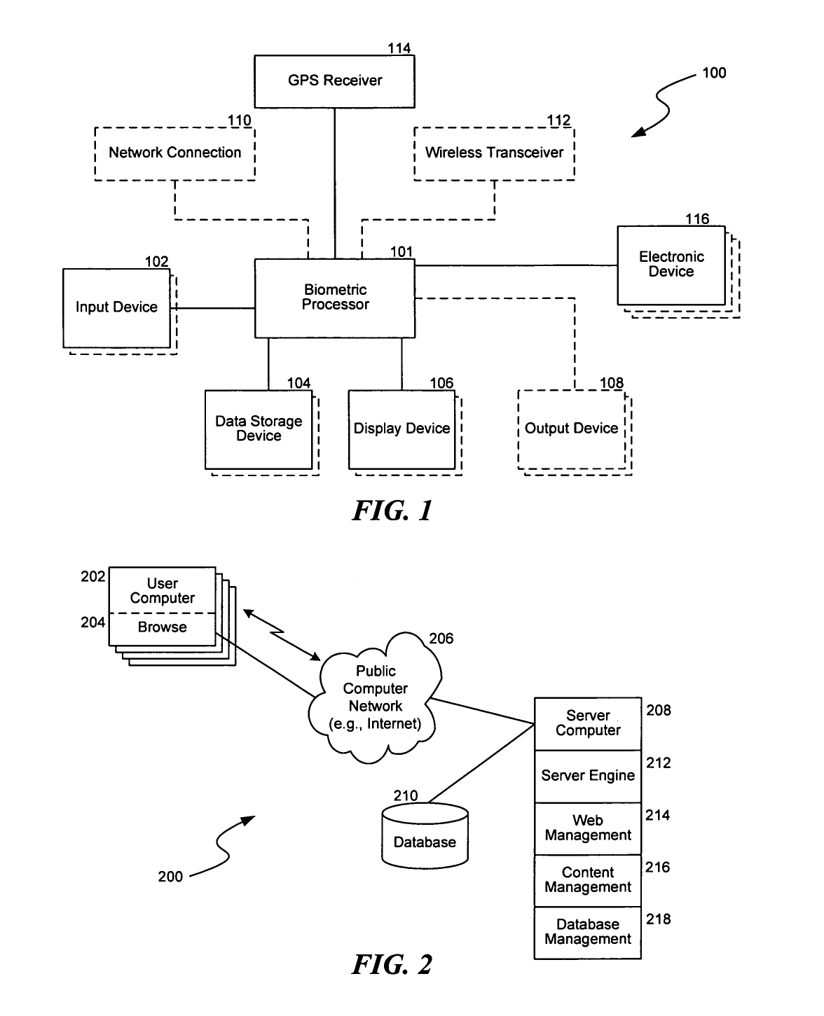

FIG. 1 is a schematic diagram of an electronic system 100 configured in accordance with an embodiment of the invention. In the illustrated embodiment, the electronic system 100 includes at least one processor 101. The processor 101 may be of the type used in a personal computer (PC), personal digital assistant (PDA), cell phone, or a multitude of other electronic devices and systems. In this regard, the processor 101 can be configured to receive information from a plurality of different user input devices 102. The user input devices 102 can include, for example, a keyboard, key pad, pointing device such as a mouse, joystick, pen, game pad, and the like. In addition, the user input devices 102 can also include one or more biometric input devices such as a microphone, scanner (e.g., a fingerprint scanner, iris scanner, face scanner, etc.), digital camera, video camera, DNA decoder, and the like. The processor 101 can also be coupled to a Global Positioning System (GPS) receiver (or transceiver) 114 for determining position, velocity, and/or time parameters, as well as one or more external computers via an optional network connection 110, a wireless transceiver 112, or other suitable link.

The processor 101 can be coupled to one or more data storage devices 104. The data storage devices 104 can include any type of computer-readable media that can store data accessible by the computer 100, such as magnetic hard and floppy disk drives, optical disk drives, magnetic cassettes, tape drives, flash memory cards, USB keys, digital video disks (DVDs), Bernoulli cartridges, RAMs, ROMs, smart cards, etc. Indeed, any medium for storing or transmitting computer-readable instructions and data may be employed, including a connection port to or node on a network such as a local area network (LAN), wide area network (WAN) or the Internet (not shown in FIG. 1).

The processor 101 can also be coupled to a display device 106 and one or more optional output devices 108. The optional output devices 108 can include, for example, a printer, plotter, speaker, tactile or olfactory output device, etc. Furthermore, the processor 101 can be configured to send control signals to one or more electronic devices 116 to control those devices. As described in greater detail below, the electronic devices 116 can be associated with a wide variety of electronically controlled systems including, for example, computer systems, communication systems, security systems, transportation systems, home appliance systems, etc.

Aspects of the invention may be practiced in a variety of other computing environments. For example, referring to FIG. 2, a distributed computing environment 200 with a web interface includes one or more user computers 202, each of which includes a browser program module 204 that permits the computer to access and exchange data with the Internet 206, including web sites within the World Wide Web portion of the Internet. The user computers 202 may be substantially similar to the computer described above with respect to FIG. 1. User computers 202 may include other program modules such as an operating system, one or more application programs (e.g., word processing or spread sheet applications), and the like. The computers may be general-purpose devices that can be programmed to run various types of applications, or they may be single-purpose devices optimized or limited to a particular function or class of functions. More importantly, while shown with web browsers, any application program for providing a graphical user interface to users may be employed, as described in detail below; the use of a web browser and web interface are only used as a familiar example here.

At least one server computer 208, coupled to the Internet or World Wide Web (“Web”) 206, performs much or all of the functions for receiving, routing and storing of electronic messages, such as web pages, audio signals, and electronic images. While the Internet is shown, a private network, such as an intranet, or other network, may indeed be preferred in some applications. The network may have a client-server architecture, in which a computer is dedicated to serving other client computers, or it may have other architectures such as a peer-to-peer, in which one or more computers serve simultaneously as servers and clients. A database 210 or databases, coupled to the server computer(s), stores much of the web pages and content exchanged between the user computers. The server computer(s), including the database(s), may employ security measures to inhibit malicious attacks on the system, and to preserve integrity of the messages and data stored therein (e.g., firewall systems, secure socket layers (SSL), password protection schemes, encryption, and the like).

The server computer 208 may include a server engine 212, a web page management component 214, a content management component 216 and a database management component 218. The server engine performs basic processing and operating system level tasks. The web page management component handles creation and display or routing of web pages. Users may access the server computer by means of a URL associated therewith. The content management component handles most of the functions in the embodiments described herein. The database management component includes storage and retrieval tasks with respect to the database, queries to the database, and storage of data such as video, graphics and audio signals.

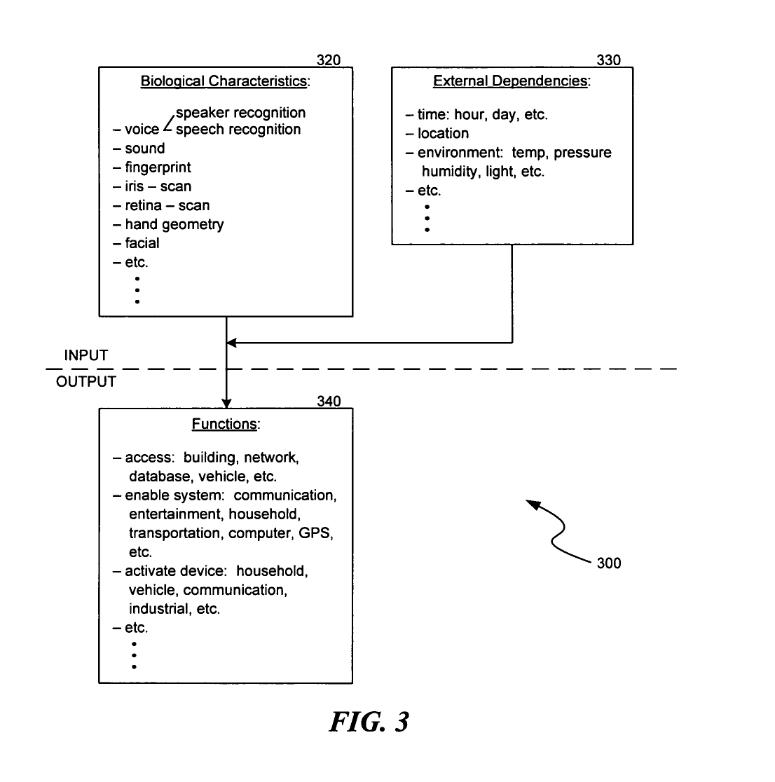

FIG. 3 is a schematic diagram illustrating a method 300 for controlling an electronic system in accordance with an embodiment of the invention. As used throughout this disclosure, the term “electronic system” is used broadly to refer to a computer system (e.g., a PC, hand-held device, main frame, etc.), a communication system (e.g., a cell phone, land line, etc.), a security system (e.g., a building entrance, vehicle entrance, international border, etc.), an entertainment system (e.g., music, video, TV, etc.), a home appliance system (e.g., automatic windows, air conditioning, lighting, food preparation, etc.), a vehicle sub-system (automobile, aircraft, watercraft, etc.), etc. As such, this term also refers to any electronic system that heretofore has been activated or otherwise controlled by manual, automatic, and/or biometric input.

In one aspect of this embodiment, the method 300 can utilize various types of biological characteristics 320 as input. The biological characteristics 320 can be associated with a particular individual or “source” requesting that the electronic system perform a particular function 340. The biological characteristics 320 can include, for example, voice, word, sound, fingerprint, iris-scan, etc. In addition to the biological characteristics 320, the method 300 can also utilize various types of external dependencies 330 as input. The external dependencies 330 can include, for example, dynamic information regarding the time of the request (e.g., day, week, year, etc.), the location of the source or the particular electronic system, the atmospheric conditions, and other factors as well. In the illustrated embodiment, the method 300 uses the biological characteristics 320 to verify and/or authenticate the source requesting the particular function. Once the source has been authenticated, the method 300 then looks to the external dependencies 330 to determine how to respond to the request.

By way of an example, if the source is a person wishing to use a particular mobile phone, the method 300 begins by authenticating the person based one or more of biological characteristics. (For example, the person can speak into a microphone on the phone for voice verification). Once the person has been authenticated, the method 300 then checks the external dependencies 330 to determine if there are other factors that should be considered before turning the phone “on.” For example, if the phone has only been authorized for use in a particular area, the method 300 verifies (through, e.g., a GPS receiver) that the phone is still within the authorized area. If the phone is within the authorized area, the phone is turned “on” for use; otherwise, the phone remains inoperative.

The foregoing example illustrates but one of the many ways the general method of FIG. 3 can be used to control an electronic device. In other embodiments, the method 300 can be used to perform a multitude of other functions 340 including, for example, controlling access (e.g., access to a building, network, database, etc.), activation (e.g., activation of a communication system, computer system, entertainment system, household system, transportation system, GPS system, etc.), and the like.

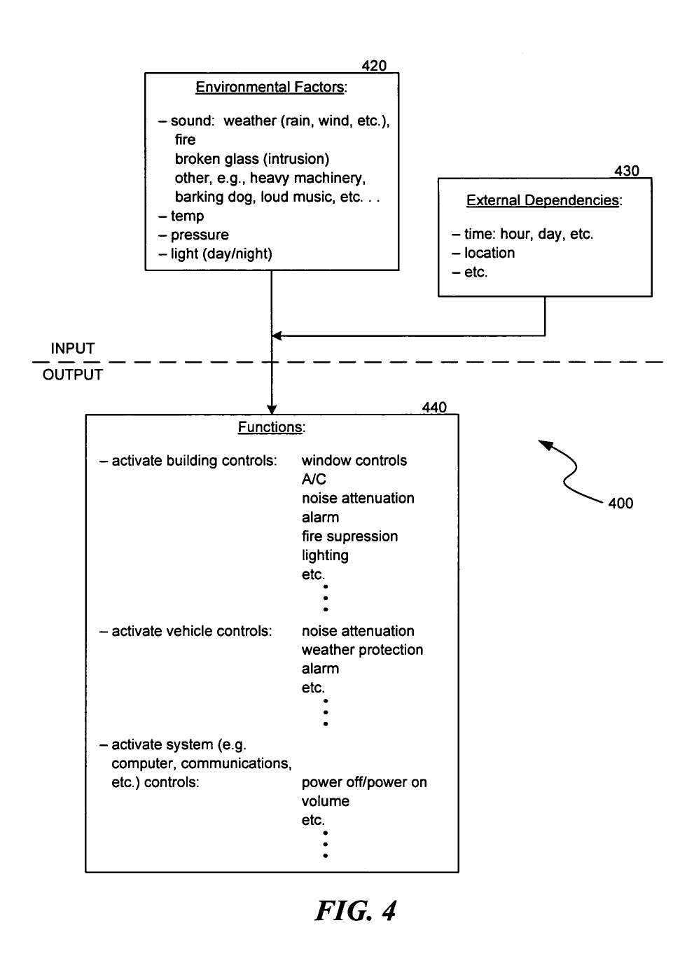

FIG. 4 is a schematic diagram illustrating a method 400 for controlling an electronic system in accordance with another embodiment of the invention. The method 400 is similar to the method 300 described above with reference to FIG. 3. In the embodiment of FIG. 4, however, the method 400 utilizes various environmental factors 420 as input, instead of (or in addition to) the biological characteristics 320 discussed above. The environmental factors 420 can include various types of sounds, such as the sound associated with different types of weather (e.g., rain, wind, etc.), the sound of fire, the sound of broken glass (intrusion), or the sound of loud or otherwise unpleasant background noise (e.g., heavy machinery, barking dog, etc.). Other environmental factors can include temperature, pressure, ambient lighting, etc. In addition to the environmental factors 420, the method 400 can also utilize dynamic information from one or more external dependencies 430 to tailor the response to the environmental factors 420. The external dependencies 430 can include, for example, time (e.g., hour, day, etc.), location, etc.

In the illustrated embodiment, the electronic system can perform a number of different functions 440 in response to the environmental factors 420 and the external dependencies 430. The functions 440 can include, for example, activating building controls (e.g., closing windows or window blinds, activating air conditioning systems, activating noise suppression systems, activating fire or burglar alarms, activating fire suppression systems, etc.). These functions can also include activating similar controls in an automobile or other vehicle.

One example of a system operating in accordance with the method 400 is a window system configured to control operation of windows and skylights in a home, office, or other building. In this example, the method 400 receives one or more environmental factors 420 (e.g., the sound of rain) indicating that it is raining heavily outside. The method 400 then checks the external dependencies 430 to determine how to respond to this information. If, for example, the external dependencies 430 indicate that a particular window or skylight is positioned in such a way that rain could enter the home, the method 400 outputs a signal to the window system instructing it to automatically close (or partially close) the particular window or skylight. A similar routine can be employed to close one or more windows and/or blinds in response to undesirable noise outside the home.

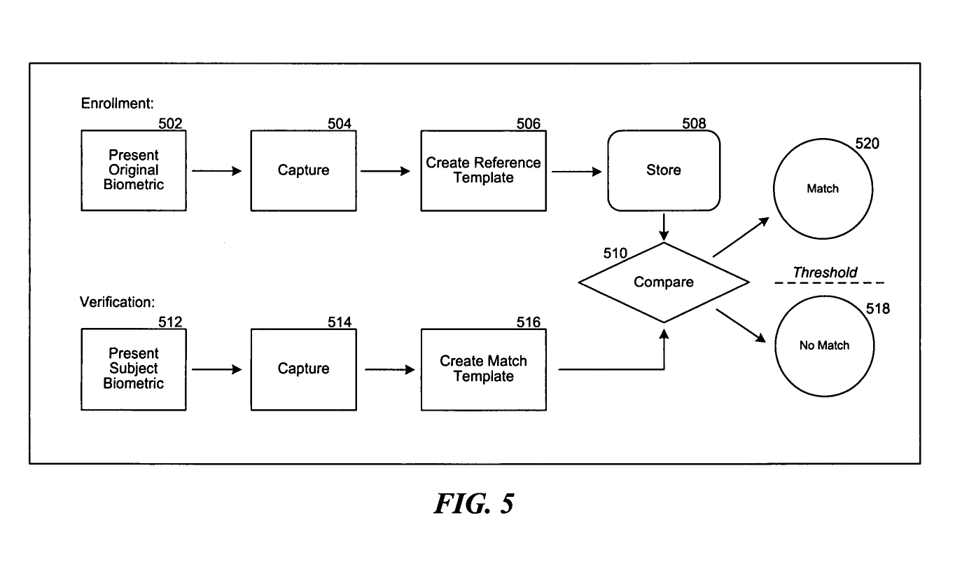

FIG. 5 is a flow diagram illustrating a two-part routine 500 for (1) enrolling a biological characteristic (an “original biometric”) in a biometric verifier and (2) verifying a subsequent biometric (a “subject biometric”) against the enrolled biometric. Enrollment begins in block 502 when the original biometric is presented for enrollment. In this embodiment, the original biometric can include a fingerprint, sound, spoken word, iris-scan, etc. In block 504, the original biometric is captured. In block 506, a reference template of the original biometric is created. In block 508, the reference template is stored.

Verification begins in block 512 when a subject biometric is presented for verification. In block 514, the routine captures the subject biometric. In block 516, the routine creates a match template that is compared to the stored reference template in decision block 510. If the results of the comparison between the match template and the reference template are above a pre-selected threshold, then the subject biometric is a match in block 520. Conversely, if the results of the comparison are less than the threshold, then the subject biometric is rejected in block 518.

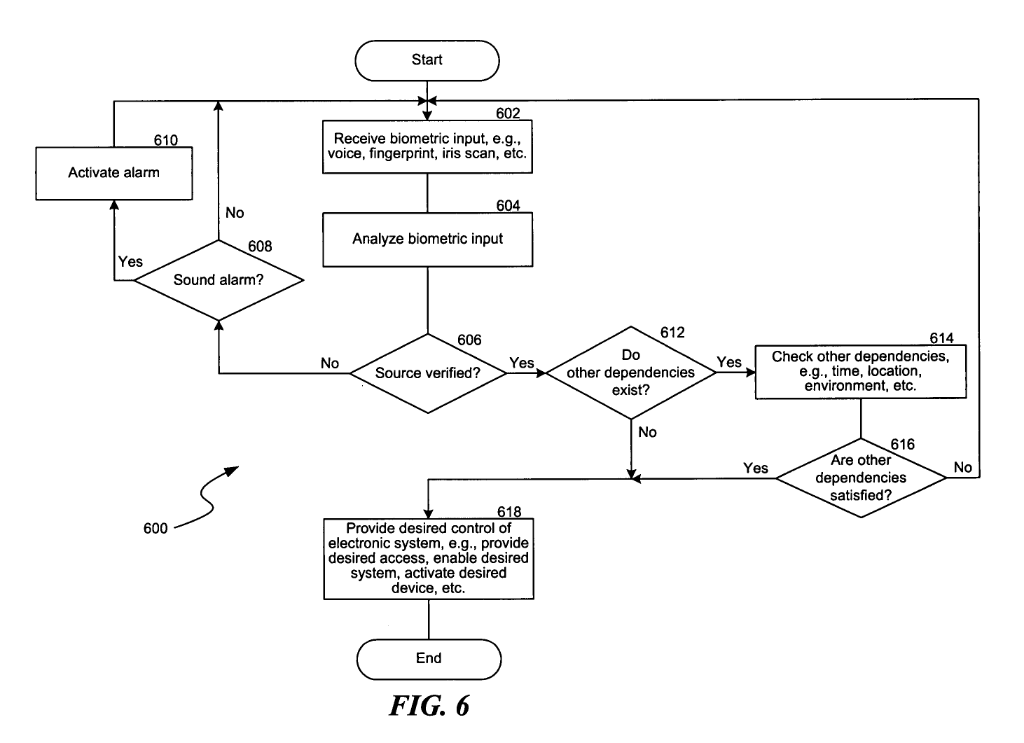

FIG. 6 is a flow diagram illustrating a routine 600 for controlling an electronic system in accordance with an embodiment of the invention. By way of examples, the electronic system can include electronically controlled gates or doors, computer systems, communication systems, home appliances, etc. In block 602, the routine receives one or more forms of biometric input from a source (e.g., a person) wishing to control the electronic system. The biometric input can include, for example, voice input, fingerprint input, etc. In block 604, the routine analyzes the biometric input. As set forth above, the analysis can include comparing a match template to a stored reference template. In addition or alternatively, the analysis can include using one or more mathematical algorithms to calculate a probability of the authenticity of the input. In decision block 606, the routine determines if the source is authentic. If not, the routine can proceed to decision block 608 and determine if an alarm should be activated to notify others of the attempt by the imposter. If so, then the routine activates an alarm in block 610. Otherwise, the routine returns to block 602.

If the source is authenticated in decision block 606, then the routine proceeds to decision block 612 and determines if other dependencies exist for this particular source and/or for the particular electronic system. If no other dependencies exist, then the routine proceeds directly to block 618. If other dependencies do exist, then in block 614 the routine checks the dependencies. The dependencies can include, time, location, environment, etc. For example, if the source is a person wishing to gain access to a particular building, then the routine may check the time of day (week, month, etc.) to confirm it is an appropriate time for the person to gain access to the building. Or, if the source is a child wishing to turn on a TV or other media device, then the routine may check the time to confirm that it is an appropriate time for the child to be watching TV. Similarly, the routine may also check the selected station, website, etc. to confirm it is on the “approved” list for the child. In these embodiments, the dependencies can be viewed as separate conditions (in addition to an authentic source) that must me met before the routine will perform the desired function.

In decision block 616, the routine determines if the other dependencies are satisfied. If the other dependencies are not satisfied, then the routine returns to block 602 without performing the desired function (e.g., without admitting the person into the building), even though the source was initially authenticated. Conversely, if the other dependencies are satisfied, then the routine proceeds to block 618 and performs the function requested by the source (e.g., admits the person into the building).

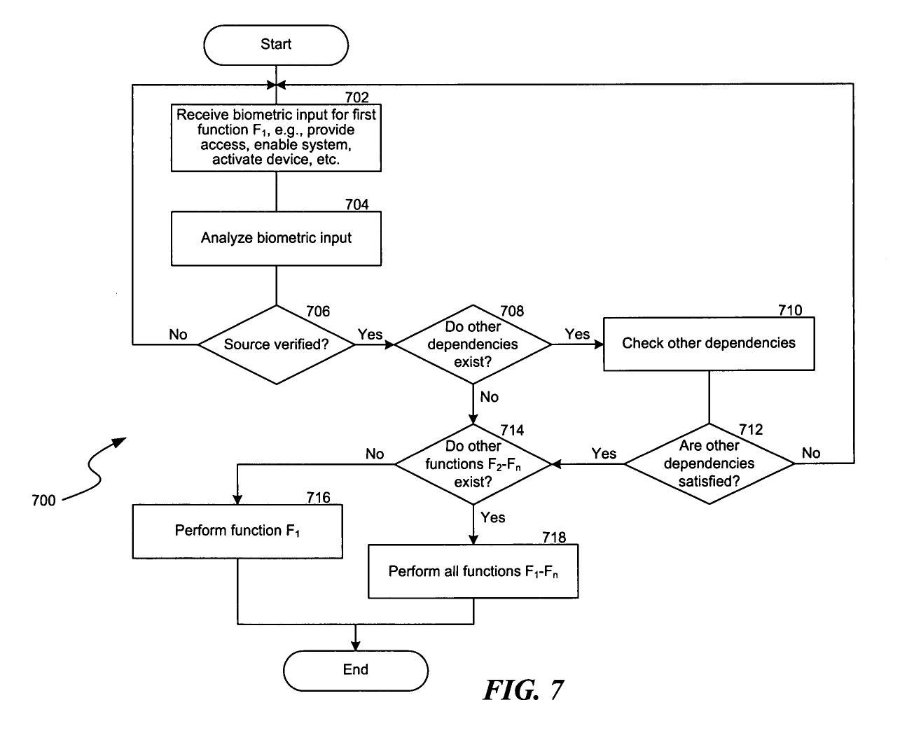

FIG. 7 is a flow diagram illustrating a routine 700 for controlling an electronic system in accordance with another embodiment of the invention. In block 702, the routine receives one or more forms of biometric input from a source (e.g., a person) wishing to control the electronic system to perform a first function F₁. By way of examples, the first function F₁ can include providing access to a building or area, activating a device, enabling a computer or communication system, etc. In block 704, the routine analyzes the biometric input. In decision block 706, the routine determines if the source is authentic based on the analysis performed in block 704. If not, the routine can return to block 702 without performing the desired function F₁.

If the source is verified as authentic in decision block 706, then the routine proceeds to decision block 708 and checks for other dependencies. If no other dependencies exist, then the routine proceeds directly to decision block 714. If other dependencies do exist, then the routine addresses the dependencies in block 710 as discussed above with reference to FIG. 6. In decision block 712, the routine determines if the other dependencies are satisfied. If not, the routine returns to block 702 without performing the desired function F₁. If so, the routine proceeds to decision block 714 to determine if other functions F₂-Fₙ exist.

In one aspect of this embodiment, the other functions F₂-Fₙ addressed in decision block 714 can correspond to other functions that the electronic system automatically performs when it receives a valid request by the source to perform the first function F₁. As an example, if the electronic system is a cell phone and the first function F₁ corresponds to an activation request from a particular user, then the second function F₂ can be an automatic billing function that automatically bills the call to the particular caller's account. If other such functions exist, then the routine proceeds to block 718 and performs all functions F₁-Fₙ. Otherwise, the routine proceeds to block 716 and performs only function F₁. After either block 716 or 718, the routine ends.

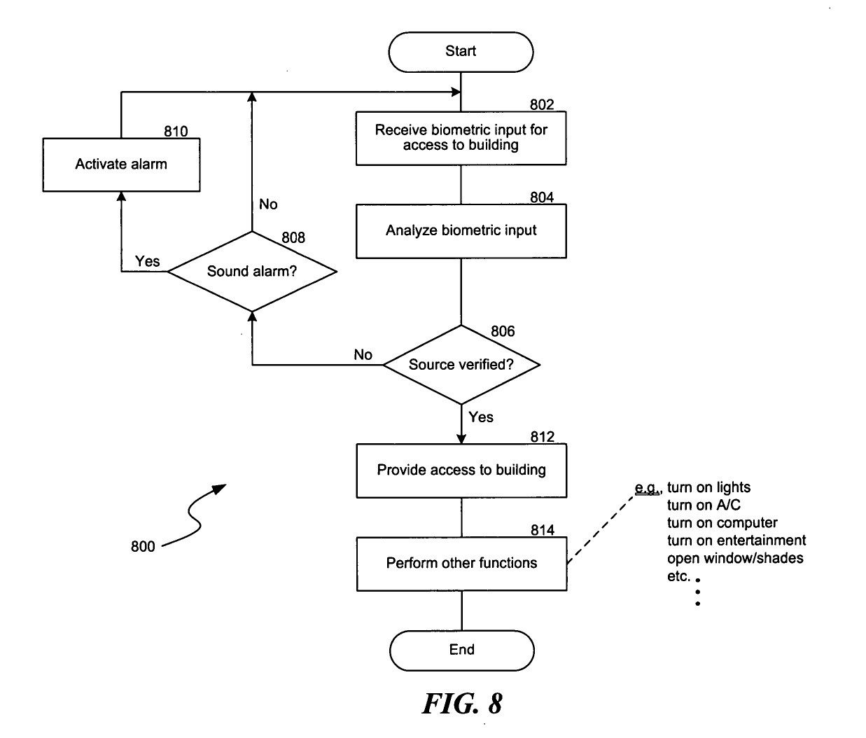

FIG. 8 is a schematic diagram illustrating a particular implementation of the routine 700 described above with reference to FIG. 7. In block 802, the routine 800 receives biometric input for controlling an electronic system. In this example, the electronic system is a security system that controls access to a building, and the source of the biometric input is a person wishing to enter the building. In block 804, the routine analyzes the biometric input. In decision block 806, the routine determines if the source is authentic. If not, the routine proceeds to decision block 808 to determine if it should sound an alarm. If so, then the routine activates an alarm in block 810. Otherwise, the routine returns to block 802 without sounding an alarm.

If the source is verified as being authentic in decision block 806, then the routine proceeds to block 812 and provides the desired function; that is, the routine admits the person into the building. In block 814, the routine performs other functions that may be source-specific, time-specific, or based on some other criteria. For example, after the person has been admitted into the building, the routine can automatically turn on lights, air conditioning, a computer, and/or background music in one or more of the rooms that the person routinely occupies. Or, if the building is the person's home and it is after a certain hour, the routine could automatically turn on the lights in part of the house. After block 814, the routine is complete.

In FIGS. 6-8, the term “source” is often used to refer to a person who provides biometric input. In other contexts in the present disclosure, however, the term “source” can also be used to refer to a device (e.g., an electrical device, clock, GPS, temperature gauge, pressure gauge, noise detector, microphone, cell phone, computer, etc.) that provides information (e.g., time information, positional information, etc.).

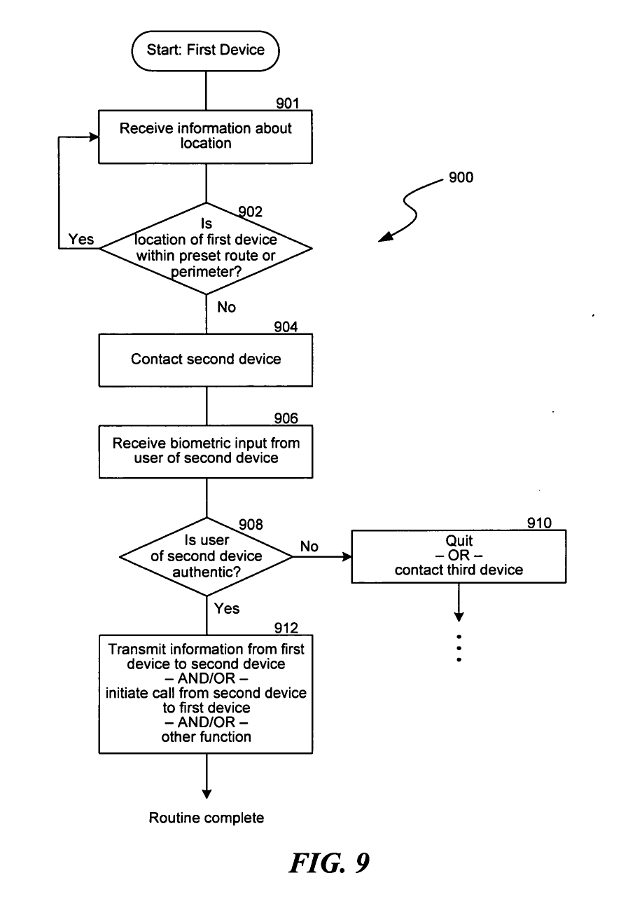

FIG. 9 is a flow diagram illustrating a routine 900 for remotely monitoring the location of a first device in accordance with an embodiment of the invention. In this embodiment, the first device can be any number of different mobile devices including, for example, a cell phone, a PDA, an on-board computer in an automobile, etc. In block 901, the routine receives information about the location of the first device. In one embodiment, the first device can include a GPS receiver for this purpose. In decision block 902, the routine determines if the location of the first device is within a preset route or perimeter. If so, then the routine returns to block 901. If not, the routine proceeds to block 904 and contacts a second device. In this embodiment, the second device can be a cell phone, PDA, or other suitable communication device.

In block 906, the routine receives biometric input (and/or some other form of user verification, etc.) from a user of the second device. In decision block 908, the routine determines if the user of the second device is authentic. If not, the routine proceeds to block 910 where it can either terminate or, instead, attempt to contact a third device and authenticate its user. Conversely, if the user of the second device is authentic, then the routine proceeds to block 912 and transmits information from the first device to the second device. In this embodiment, transmitting information can include sending a text message and/or some other type of signal to the second device alerting the user of second device to the fact that the first device is no longer within the preset route or perimeter. In addition or alternatively, in block 912 the routine can initiate a call from the second device to the first device so that the user of the second device can instruct the user of the second device to return to the preset route or perimeter. After block 912, the routine is complete.

The routine described above with reference to FIG. 9 can be implemented in a number of different embodiments. In one embodiment, for example, a first person is provided with a first mobile phone that includes a GPS receiver. The first mobile phone can include a processing device that is programmed to contact a second mobile phone held by a second person in the event that the first mobile phone leaves a preset route or perimeter. For example, if a parent wishes to monitor the whereabouts of a child, the parent can provide the child with a cell phone equipped with a GPS receiver and a processing component configured to call the parent in the event the cell phone (and the child) travels outside a preset boundary. By way of example, the boundary may be set as a sufficiently wide path between the child's home and school. When the child's cell phone contacts the parent's cell phone, the parent's cell phone can prompt the parent for biometric input to authenticate the parent. This prevents the child's cell phone from inadvertently establishing a line of communication with an unknown third party. Once the parent has been authenticated, the parent can receive information via his or her cell phone indicating the location of the child. In addition or alternatively, the parent's cell phone can automatically dial the child's cell phone so that the parent can confirm the well-being of the child and instruct him or her to return immediately to the preset boundary. In a further aspect of this embodiment, the child's cell phone can include a fingerprint scanner or other type of biometric verifier with which the child can periodically verify that he or she is in possession of his or her cell phone. This prevents the child from traveling outside of the preset boundary without the cell phone.

As an extension of the above example, the child's cell phone (or other person's cell phone, computer, or other electronic device) can be configured to contact the parent if other conditions are met in addition to or exclusive of whether or not the child deviates from the preset route. For example, in one embodiment, the child's cell phone can be configured to contact the parent's cell phone immediately if a sensor (e.g., a microphone) on the child's cell phone picks up a signal indicative of a potentially harmful situation. For example, the child's cell phone could include a microphone and a processor configured to respond to the sound of fire by contacting the parent's cell phone so that the parent can take action. In addition, or alternatively, the child's cell phone could also include a smoke detector, a temperature sensor, or other verifier to alert the parent in the event of a potentially harmful or otherwise undesirable situation.

Various embodiments of the invention as described above can include a “choice” of biometric authentication methods. For example, if a particular electronic system includes a voice recognition tool and it is not possible for the tool to analyze a voice pattern because, for example, there is too much background noise, then the electronic system can include the capability to automatically request another type of biometric input. Such other types of biometric input can include, for example, fingerprint scans, iris-scans, etc.

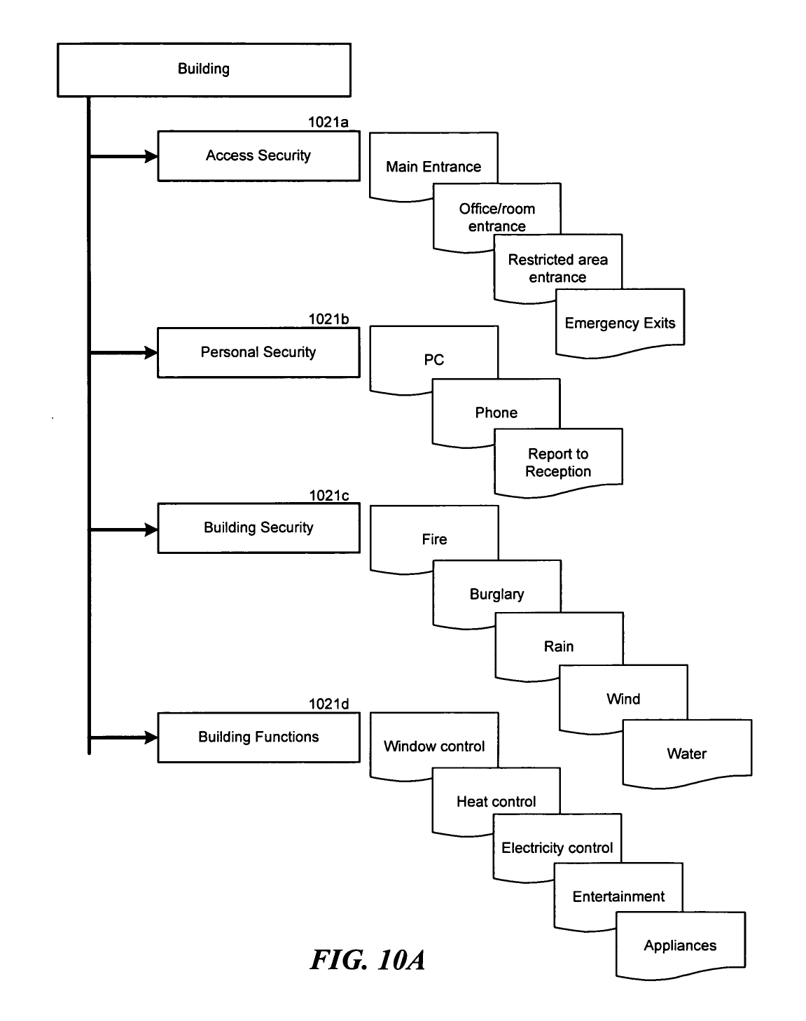

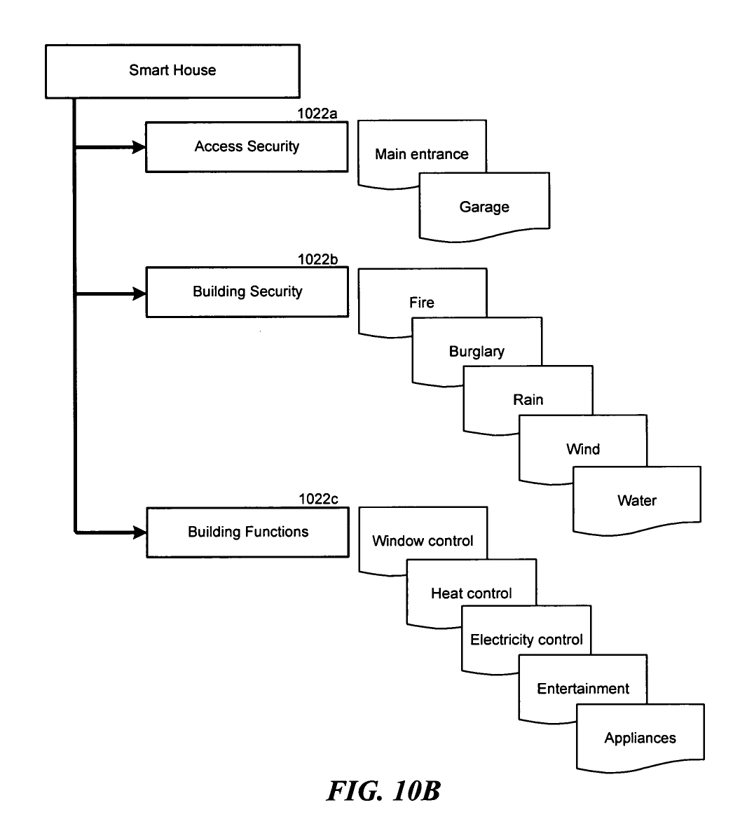

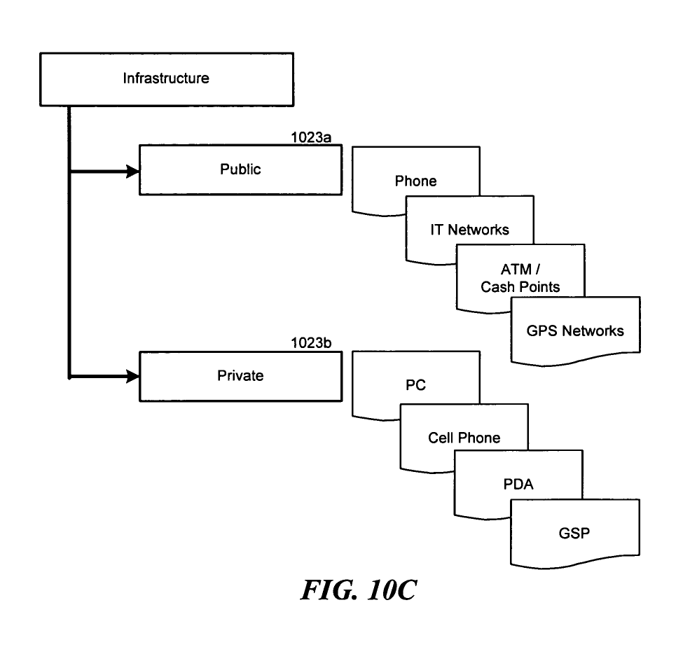

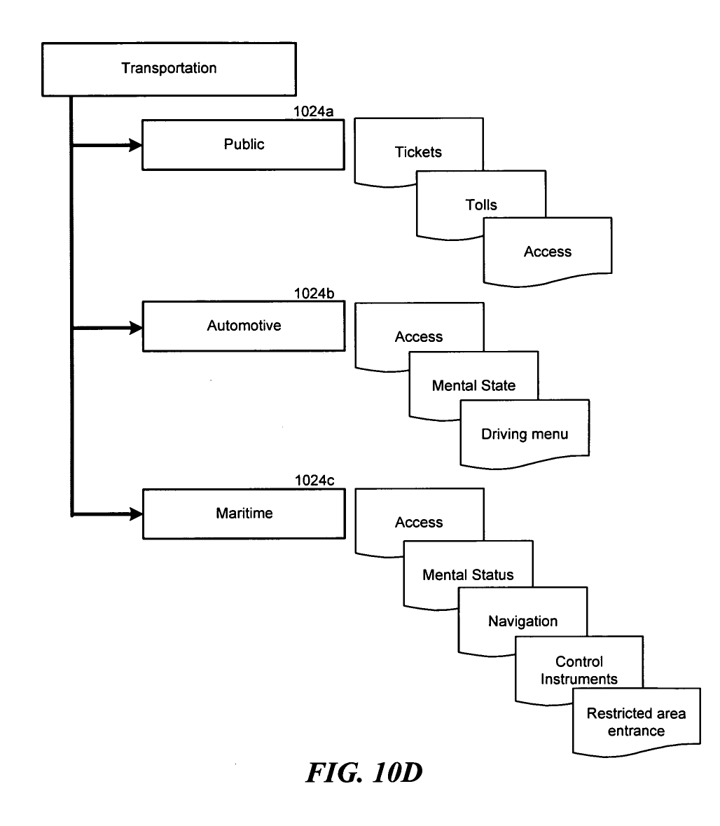

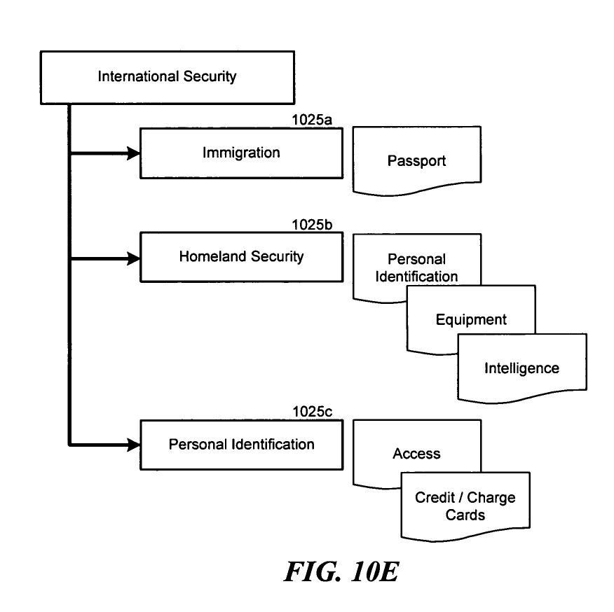

FIGS. 10A-10E are a series of schematic diagrams illustrating various applications for embodiments of the invention described above. The following applications are provided by way of example only. Accordingly, the present invention is not limited to these applications but extends to all other applications falling within the spirit and scope of the present disclosure.

FIG. 10A illustrates various uses of the biometric methods described above in a building. For example, one use these methods is to provide an access security function 1021a by controlling access to a main entrance, an office or room, or a restricted area. Another use is to provide a personal security function 1021b by controlling access to a PC, phone, etc. A further use is to provide a building security function 1021c by detecting (e.g., by listening for) and responding to a fire, a burglary, rain, wind, water, etc. An additional use is to provide various building functions 1021d through operation of window controls, heat controls, electricity controls, entertainment controls, appliance controls, etc.

FIG. 10B illustrates various uses of the biometric methods described above in a “smart house.” For example, one use of these methods is to provide an access security function 1022a by controlling access to the house at a main entrance or garage. Another use is to provide a building security function 1022b by detecting and responding to a fire, a burglary, rain, wind, water, etc. A further use is to provide various building functions 1022c through operation of window controls, heat controls, electricity controls, entertainment controls, appliance controls, etc.

FIG. 10C illustrates various uses of the biometric methods described above in an electronic infrastructure. For example, one use of these methods is to provide a public function 1023a by facilitating access to phone systems, IT networks, ATMs, GPS networks, etc. Another use is to provide a private function 1023b by facilitating access and/or control of a PC or other computer system, a cell phone, a PDA, a GPS, etc.

FIG. 10D illustrates various uses of the biometric methods described above in the area of transportation. For example, one use of these methods is to provide a public function 1024a by facilitating payment of tickets and tolls and access to various public thoroughfares, etc. Another use is to provide an automotive function 1024b by controlling access to, and operation of, a car by a particular individual or individuals. In addition, the automotive function 1024b can also be used to disable the car if the operator's speech or other biometric characteristics indicates that the driver's mental condition is impaired and, hence, the driver should not be operating a motor vehicle. One example of this embodiment is a car that requires the driver to speak into a voice verifier before the ignition system is enabled. If the voice verifier determines that, based on the operator's speech, the operator is impaired (e.g., intoxicated), then the car will remain inoperative. In another embodiment, a particular car or service vehicle may only be intended for use by a particular individual or group of individuals in a particular area. In this embodiment, the car can include a biometric verifier (e.g., a voice verifier) and a GPS receiver. The biometric verifier can be used to ensure that only the appropriate individual or individuals are operating the car, and the GPS receiver can be used to ensure that the car is operated only in the designated area. A further use of the methods described above is to provide a maritime function 1024c. The maritime functions include, for example, controlling access to particular vehicles and/or waterways, monitoring operator mental state, controlling use of navigation equipment and other instruments, etc.

FIG. 10E illustrates various uses of the biometric systems described above in the area of international security. For example, one use of these methods is to provide an immigration function 1025e by verifying and/or authenticating passports. Another use of these methods is to provide a homeland security function 1025b by facilitating personal identification, equipment identification and verification, and intelligence gathering. A further use of these methods is to provide a personal identification function 1025c by controlling personal access to various locations and by verifying the authenticity of credit/debit card charges.

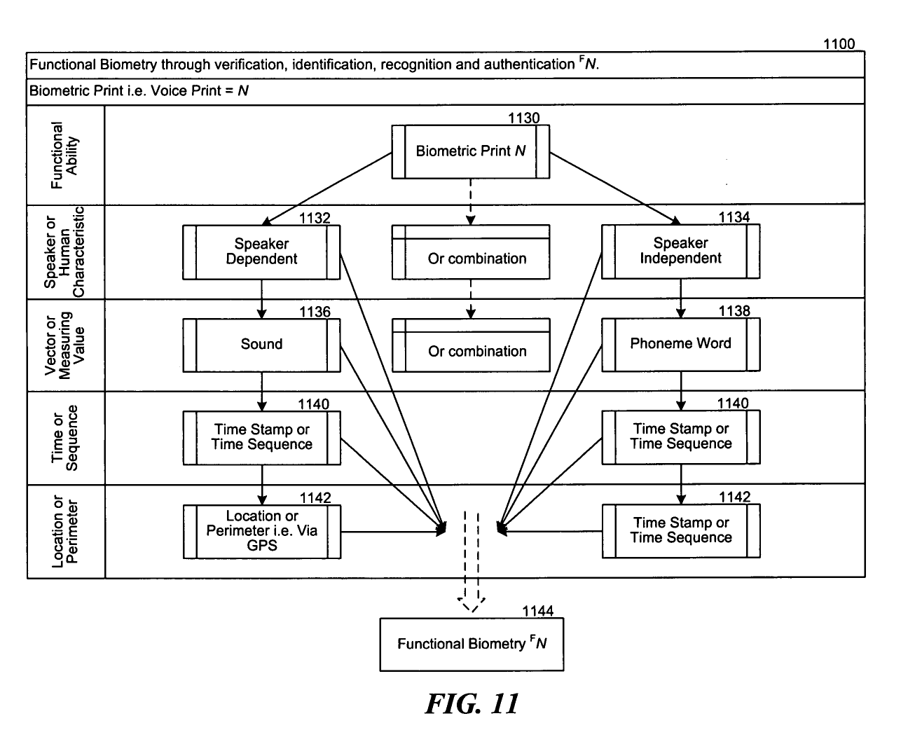

FIG. 11 is a schematic diagram of a functional biometry model 1100 configured in accordance with an embodiment of the invention. In one aspect of this embodiment, the biometry model 1100 has the ability to verify a biometric print 1130. In the illustrated embodiment, the biometric print 1130 is a voice print. In other embodiments, however, the biometric print 1130 can include other forms of biometric input including fingerprint, iris-scan, and other inputs. The biometric print 1130 can be analyzed for a speaker dependent characteristic 1132, a speaker independent characteristic 1134, or a combination of speaker dependent and independent characteristics. In the case of speaker dependent characteristics, the biometry model 1100 can analyze a sound vector 1136. In the case of a speaker independent characteristic, the biometry model 1100 can analyze a phoneme. Alternatively, the biometry model 1100 can analyze a combination of sound or phoneme vectors. Whether analyzing a sound or phoneme vector, the biometry model 1100 can utilize a time stamp or sequence 1140. In addition, the biometry model 1100 can also utilize location data 1142 from a GPS. If the biometric print 1130 is verified, then the functional biometry model 1100 can send a command to an associated electronic system to perform a selected function.

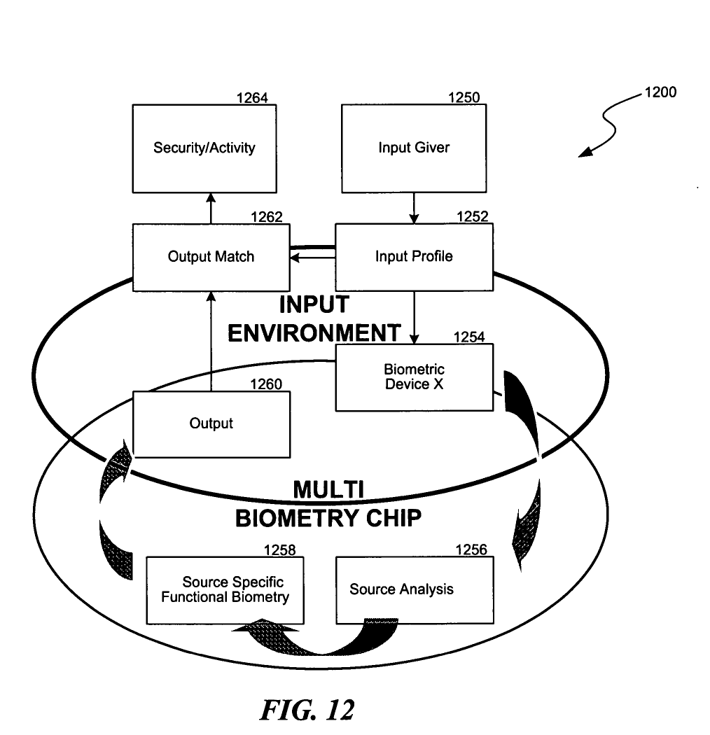

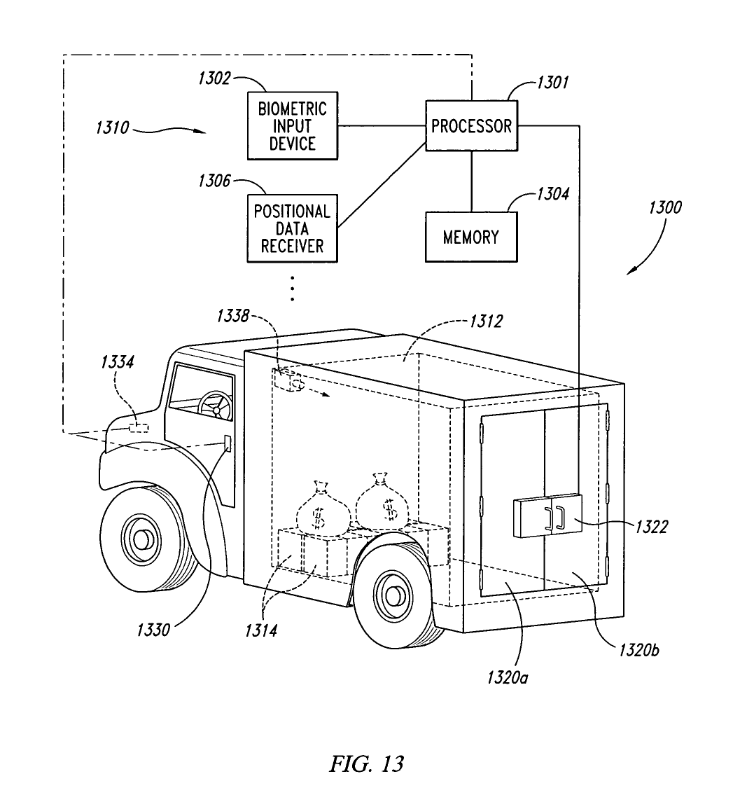

FIG. 12 is a schematic diagram of a biometric engine 1200 configured in accordance with an embodiment of the invention. In one aspect of this embodiment, the biometric engine 1200 can be implemented as an “operating system on a semi-conductor chip” for use in various types of communication, computer, home appliance, and other systems. The biometric engine 1200 includes a user interface 1250, an input profiler 1252, and a biometric device 1254. The user interface 1250 can include one or more devices for receiving biometric input from a source including, for example, a fingerprint scanner, a microphone, an iris scanner, etc.

Biometric input from the user interface 1250 is provided to the input profiler 1252. The input profiler 1252 identifies the particular type of biometric input (e.g., iris, fingerprint, voice, etc.) and processes the input with a header file for use by the biometric device 1254. The biometric device 1254 reads the header file to determine the data structure, and identifies the subsequent processing that is required to verify the particular type of biometric input. The biometric device 1254 then converts the biometric data into a usable operating system form and transmits the data to an analyzer component 1256. Here, the data is compared to a template to determine a match score. Alternatively, the analyzer component 1256 can also perform a mathematical algorithm to determine the probability of the biometric data being authentic. The analyzer component 1256 then transmits a verification score and/or other instructions to a functional biometry component 1258. The functional biometry component 1258 determines, based on the verification of the biometric input, what output to transmit to the particular electronic devices and/or system under the control of the biometric engine 1200. The particular form of the output can be dependent upon the particular source or the particular electronic system.

In another aspect of this embodiment, the biometric engine 1200 further includes an output module 1260 that packages the output signals for the particular recipient devices. The output instructions are then transmitted to one or more output devices 1262 to control the devices in accordance with the functional request from the source. The resulting functions can represent one or more security activities 1264.

The methods and systems described above can be implemented in a number of different embodiments in accordance with the present invention. For example, in one embodiment, a system configured in accordance with the present invention can be configured to detect a particular sound and isolate the sound by counter-phasing the sound with a suitable recording. Such a system can be used in various settings, including in the home as a noise attenuation device.

While various embodiments of the invention described above use voice input for speaker identification and/or verification. However, these and other embodiments of the invention can similarly use voice input for speech recognition. In this manner, various types of voice input can be analyzed to identify a command for controlling an electronic system. Accordingly, various embodiments of the invention can include a processing device configured to recognize speech commands. The commands can be used as part of a home automation system or as a stand alone unit. In the foregoing manner, a single voice input can be used for (1) speaker recognition and/or (2) speech recognition for interpreting a command or other instruction, identification information, etc.

In another embodiment of the invention, an electronic system can be configured to automatically close windows, doors, and/or similar structures in a home, office, or other building when the system detects an outside noise level that reaches a preselected level that is undesirable to the occupants. In addition, the electronic system can also be configured to automatically open the doors and/or windows in the event that the outside noise level subsides. Similar systems can be configured to detect sounds of intrusion (i.e., glass breaking), storm conditions, fire hazards, etc.

In another embodiment of the invention, an operating system for a car, aircraft, boat, or other vehicle, can be configured to interpret a particular noise or utterance in regards to a command, action, or other function that controls operation of the vehicle. Such a system can be used for vehicle navigation and other operational features. A control system operating in this manner can be configured to respond to a singular, multi-dependent, or non-dependent biometric factor or other interpretable data/factors.

The various biometric systems and methods described above can be recorded on a number of different types of computer readable media for use in computers, cell phones, PDAs, and other devices. For example, in one embodiment, a USB key containing a biometric routine can be operably coupled to a PC or other computer system. At startup, a PC drive recognizes and acknowledges the USB key, and loads the biometric routine onto the PC hard drive or other storage medium. Then, the first time the user attempts to log-on, the routine causes the PC to display a prompt that requests the user to provide biometric input (e.g., speak a word, scan a fingerprint, etc.) which the routine can then store as an original biometric template. The next time the user attempts to log on to the PC, the routine will prompt the user for the same type of biometric input, which the routine will then compare to the template to determine the authenticity of the user. The foregoing embodiment is equally applicable to any type of processing device including, for example, a hand-held device such as a PDA, cell phone, etc.

In some embodiments, the biometric methods disclosed herein can be performed by a single electronic device or system. In other embodiments, however, various portions of the methods described above can reside on, and/or be performed by, two or more different electronic devices. In one embodiment, for example, a first device can receive biometric input, analyze and verify the biometric input, interpret an instruction from the biometric input, and then send a command based on the instruction to a second electronic device for performing a corresponding function. In another embodiment, the first device can receive a biometric input (e.g., voice input) and prepare a signal corresponding to the voice input. The first device can then transmit the signal corresponding to the voice input to a second device wherein the signal is then analyzed to determine the authenticity of the source. Once the second device determines the authenticity of the source, the second device can interpret the instructions and perform the desired function or transmit a signal to a third device to perform the desired function.

FIG. 13 is a partially schematic isometric view of a vehicle 1300 (e.g., a truck) having a biometric system 1310 configured in accordance with an embodiment of the invention. In one aspect of this embodiment, the vehicle 1300 includes a cargo compartment 1312 which is accessible via one or more doors 1320 (identified individually (identified individually as a first door 1320a and a second door 1320b). The doors 1320 can be secured in a closed position by a computer-controlled lock 1322. The lock 1322 is operably connected to a processor 1301, which is in turn operably connected to one or more biometric input devices 1302, a positional data receiver 1306, and memory 1304.

In the illustrated embodiment, the input device 1302 can receive biometric input (e.g., voice, fingerprint, iris scan, etc.) from a source (e.g., a vehicle operator) wishing to open the doors 1320 to the cargo compartment 1312. The positional data receiver 1306 can receive positional information via signals (e.g., wireless signals) from a satellite or other source. In one embodiment, the positional data receiver 1306 can include a GPS receiver or similar device. The memory 1304 can include one or more computer-readable routines for analyzing and/or otherwise processing the biometric information received from the input device 1302 and the positional information received from the data receiver 1306.

The vehicle 1300 can be used to securely transport money 1314 and/or other items in one embodiment as follows. First, the money 1314 is loaded into the cargo compartment 1312 at a first location. In one embodiment, the first location can be a central location such as a money processing facility operated by the company that owns the vehicle 1300. Once the vehicle 1300 has been loaded at the first location, the doors 1320 are secured and locked in the closed position (as shown) with the lock 1322. Next, the vehicle 1300 can be driven to the second location. In one embodiment, the second location can be a bank or other financial institution that needs the money 1314 for daily operations. In another embodiment, the first location can be a bank or other site where money or other valuables are picked up, and the second location can be a central facility where the money or other valuables are dropped off.

Once at the second location, the vehicle operator (or other authorized personnel) can initiate unlocking of the doors 1320 by inputting biometric data to the processor 1301 via the input device 1302. For example, in one embodiment, the operator can submit voice data via a microphone or other device. In other embodiments, the operator can submit a fingerprint, iris or retinal scan, and/or other forms of biometric input to the processor 1301. The processor 1301 analyzes the biometric input to determine if the person submitting the input is authorized to unlock the doors 1320. In one embodiment, the processor 1301 can analyze the biometric input by comparing it to a reference template to determine if the level of match meets or exceeds a preset threshold, as described above with reference to FIG. 5. If the biometric input sufficiently matches the stored template, then the processor 1301 analyzes positional data from the receiver 1306 to determine the location of the vehicle 1300. If the positional data indicates that the vehicle 1300 is within a preset area that is at, or sufficiently near, the second location (e.g., on a street adjacent to the second location), then the processor 1301 transmits a signal to unlock the lock 1322, thereby providing access to the cargo compartment 1312. Conversely, if the vehicle 1300 is not within the preset area, then the processor 1301 will not unlock the lock 1322—even if the person submitting the biometric input was determined to be authorized to open the doors 1320. In a further embodiment, the vehicle 1300 can also include a camera 1338 (e.g., a video camera) in the cargo compartment 1312 that is automatically activated when the doors 1320 are opened to record any access into the cargo compartment.

The embodiment of the present invention described above adds an extra layer of security to biometric access systems by requiring that an additional parameter be met before access is granted. Specifically, the present invention requires that the vehicle be within a prescribed area before access to the vehicle, or a portion of the vehicle, is granted. This feature prevents the vehicle 1300 from being opened at an unauthorized location—even if the person submitting the biometric input is authorized to open the vehicle. For example, if the vehicle 1300 is hijacked and driven to a remote location, the processor 1301 will prevent the lock 1322 from opening, even if the hijackers are able to force the driver to provide the requisite biometric input. In this manner, the processor 1301 can ensure that the cargo compartment 1312 is only opened by authorized personnel in authorized locations (e.g., a central processing facility, bank, store, etc.).

As those of ordinary skill in the art will appreciate, various modifications to the methods and systems described above with reference to FIG. 13 can be made without departing from the spirit or scope of the present invention. In one embodiment, for example, the processor 1301 can be operably connected to a cab door lock 1330 and/or an ignition system 1334 on the vehicle 1300. In these embodiments, the biometric access system 1310 can be used as described above to limit operation of the door lock 1330 and/or the ignition system 1334 to certain individuals and/or certain locations.

Biometric systems at least generally similar in structure and function to the biometric system 1310 described above can also be used in a rental vehicle business. In one embodiment, for example, a company that rents cars can record a piece of biometric information for each person desiring to rent a car. For example, the company can record voice data or a fingerprint for each such person at the time the person applies to rent a car. This biometric input can then be processed to create a biometric template for that particular person. The template can then be transmitted (e.g., wirelessly transmitted) to a biometric processing system on the particular car that the person will be renting, and stored on memory as a “biometric key.” The person then submits the corresponding biometric input each time he or she attempts to start the car (enter the car, etc.). For example, if the biometric key includes a fingerprint template, then the person has his or her fingerprint scanned by an input device that is operably connected to the biometric processor in the car. The biometric processor compares the input to the template and authenticates the person before enabling the car. This approach ensures that only those individuals who rent the car (or are otherwise designated to operate the car) actually operate the car. In addition, the car can also include a GPS receiver (see the positional data receiver of FIG. 13) that sends positional information to the biometric processor. The biometric processor can use the positional information to ensure that the car is within a preset boundary (e.g., a state, city, etc.) before enabling, e.g., the car's ignition system. This feature prevents rental cars from being taken out of state or to other unauthorized locations. A further feature of this system is that it gives the rental car company a method for remotely disabling the car's ignition system if the renter fails to return the car on a preset date, or if the renter runs out of valid funds to pay for an extended rental term.

Although, in the embodiments described above with reference to FIG. 13, the biometric processing system is carried on the particular vehicle (e.g., the vehicle 1300, in other embodiments, the vehicles configured in accordance with the present invention can include transceivers and/or other known devices that exchange information with remote biometric processing systems. In these embodiments, each vehicle can include its own biometric input device and/or GPS receiver, and it can transmit biometric and/or positional input to the remote processing system to authenticate vehicle operators and/or verify vehicle locations.

In yet another embodiment, methods and systems at least generally similar to those described above can be used with aircraft, tanks, trucks and/or other vehicles in military and non-military applications. For example, a biometric processor can ensure that such vehicles are only operated by authorized personnel by rendering the ignition system (weapon system, etc.) of such vehicles inoperative if attempts are made to operate the system without the proper biometric input. In addition, a GPS receiver or other positional device can be implemented as described above to ensure that the vehicle and/or particular systems on the vehicle are only operated in a particular area. As the foregoing examples make clear, there are numerous ways that the biometric systems disclosed herein can be used to add security to different aspects of vehicle operation and/or related commercial enterprises.

In general, the detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. Also, while processes or blocks are at times shown as being performed in series, these processes or blocks may instead be performed in parallel, or may be performed at different times.

Aspects of the invention may be stored or distributed on computer-readable media, including magnetically or optically readable computer discs, hard-wired or preprogrammed chips (e.g., EEPROM semiconductor chips), nanotechnology memory, biological memory, or other data storage media. Indeed, computer implemented instructions, data structures, screen displays, and other data under aspects of the invention may be distributed over the Internet or over other networks (including wireless networks), on a propagated signal on a propagation medium (e.g., an electromagnetic wave(s), a sound wave, etc.) over a period of time, or they may be provided on any analog or digital network (packet switched, circuit switched, or other scheme). Those skilled in the relevant art will recognize that portions of the invention reside on a server computer, while corresponding portions reside on a client computer such as a mobile or portable device, and thus, while certain hardware platforms are described herein, aspects of the invention are equally applicable to nodes on a network.

The teachings of the invention provided herein can be applied to other systems in addition to the systems described herein. Further, the elements and acts of the various embodiments described herein can be combined to provide further embodiments. In addition, aspects of the invention can be modified, if necessary, to employ the systems, functions, and concepts of the various references described above to provide yet further embodiments of the invention.

These and other changes can be made to the invention in light of the above Detailed Description. While the above description details certain embodiments of the invention and describes the best mode contemplated, no matter how detailed the above appears in text, the invention can be practiced in many ways. Details of the invention may vary considerably in its implementation details, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention.

From the foregoing, it will be appreciated that specific embodiments of the invention have been described herein for purposes of illustration, but that various modifications may be made without deviating from the spirit and scope of the invention. For example, aspects of the invention described in the context of particular embodiments may be combined or eliminated in other embodiments. Further, while advantages associated with certain embodiments of the invention have been described in the context of those embodiments, other embodiments may also exhibit such advantages, and not all embodiments need necessarily exhibit such advantages to fall within the scope of the invention. Accordingly, the invention is not limited, except as by the appended claims.

I claim:

1. A method for controlling access to a portion of a vehicle, the method comprising:
receiving biometric input;
determining, based on the biometric input, if the source of the biometric input is authorized to access the portion of the vehicle;
receiving vehicle location information;
determining, based on the vehicle location information, if the vehicle is in an acceptable location to allow access to the portion of the vehicle; and
allowing access the portion of the vehicle when, based on the biometric input, the source of the biometric input is authorized to access the portion of the vehicle, and when, based on the location information, the vehicle is in an acceptable location to allow access to the portion of the vehicle.

2. The method of claim 1 wherein receiving vehicle location information includes receiving a radio signal indicating the vehicle is at least proximate to a preselected location.

3. The method of claim 1 wherein receiving vehicle location information includes receiving information from a satellite via a GPS receiver carried by the vehicle.

4. The method of claim 1 wherein allowing access to the portion of the vehicle includes automatically unlocking the portion of the vehicle when, based on the biometric input, the source of the biometric input is authorized to access the portion of the vehicle, and when, based on the location information, the vehicle is in an acceptable location to unlock the portion of the vehicle.

5. The method of claim 1 wherein allowing access to the portion of the vehicle includes automatically unlocking a car when, based on the biometric input, the source of the biometric input is authorized to access the car, and when, based on the location information, the car is an area within which the source of the biometric input is authorized to operate the car.

6. The method of claim 1 wherein the vehicle is a truck, and wherein allowing access to the portion of the vehicle includes allowing access to a cargo portion of the truck.

7. The method of claim 1 wherein the vehicle includes a secure cargo portion configured to carry money, and wherein allowing access to the portion of the vehicle includes allowing a person to access the cargo portion of the vehicle to remove the money.

8. The method of claim 1 wherein the vehicle includes a secure cargo portion configured to carry money and a video camera positioned proximate to the secure cargo portion, wherein allowing access to the portion of the vehicle includes allowing a person to access the cargo portion of the vehicle to remove the money, and wherein the method further comprises activating the video camera in response to the person accessing the cargo portion of the vehicle.

9. The method of claim 1 wherein the vehicle includes a secure cargo portion configured to carry money, and wherein allowing access to the portion of the vehicle includes allowing a person to access the cargo portion of the vehicle to remove the money when, based on the location information, the vehicle is located proximate to at least one of a preselected bank and business location.

10. The method of claim 1 wherein receiving biometric input includes receiving voice data from a person, and wherein determining if the source of the biometric input is authorized to access the portion of the vehicle includes determining if the voice data sufficiently matches a prerecorded template.

11. A method for securely transporting one or more items from a first location to a second location, the method comprising:
loading the items into a cargo compartment of a vehicle at the first location;
locking the cargo compartment to prevent unauthorized access to the items;
moving the vehicle from the first location to a third location;
receiving biometric input from a person at the third location;
determining, based on the biometric input, if the person is authorized to access the cargo compartment of the vehicle;
receiving vehicle location information at the third location;
determining, based on the location information, if the third location is at least proximate to the second location; and
unlocking the cargo compartment at the third location when, based on the biometric input, the person is authorized to access the cargo compartment, and when, based on the location information, the third location is at least proximate to the second location.

12. The method of claim 11 wherein loading the items into a cargo compartment of a vehicle at the first location includes loading the items into a trunk of a car at the first location.

13. The method of claim 11 wherein receiving vehicle location information at the third location includes receive positional data via a satellite.

14. The method of claim 11 wherein loading the items into a cargo compartment of a vehicle at the first location includes loading money into the cargo compartment of an armored truck at the first location.

15. The method of claim 11 wherein loading the items into a cargo compartment of a vehicle at the first location includes loading money into the cargo compartment of an armored truck at a central money processing location, and wherein unlocking the cargo compartment at the third location includes unlocking the cargo compartment at a bank.

16. A vehicle comprising:
a compartment;
a door positioned adjacent to the compartment;
a lock associated with the door; and
a biometric processor operably connected to the lock, wherein the biometric processor is configured to operate the lock based on biometric input from a person.

17. The vehicle of claim 16 wherein the biometric processor is configured to transmit a signal causing the lock to allow the door to be opened when the biometric processor determines, based on the biometric input, that the person is authorized to access the compartment.

18. The vehicle of claim 16, further comprising a microphone, wherein the biometric processor is configured to automatically operate the lock based on voice input received from the person via the microphone.

19. The vehicle of claim 16 wherein the vehicle further includes a receiver configured to transmit positional data to the biometric processor, and wherein the biometric processor is further configured to operate the lock based on the biometric input from the person and the positional data from the receiver.

20. The vehicle of claim 16, further comprising a positional data receiver configured to provide positional input to the biometric processor, and wherein the biometric processor is further configured to operate the lock based on the biometric input from the person and the positional input from the positional data receiver.

21. The vehicle of claim 16, further comprising a GPS receiver configured to provide positional input to the biometric processor, and wherein the biometric processor is further configured to operate the lock based on the biometric input from the person and the positional input from the GPS receiver.

22. A vehicle comprising:
a propulsive motor;
an ignition system for starting the motor; and
a biometric processor operably connected to the ignition system, wherein the biometric processor is configured to enable the ignition system based on biometric input from a person.

23. The vehicle of claim 22 wherein the biometric processor is configured to transmit a signal enabling the ignition system to start the motor when the biometric processor determines, based on the biometric input, that the person is authorized to operate the vehicle.

24. The vehicle of claim 22, further comprising a microphone, wherein the biometric processor is configured to automatically enable the ignition system based on voice input received from the person via the microphone.

25. The vehicle of claim 22 wherein the vehicle further includes a receiver configured to transmit positional data to the biometric processor, and wherein the biometric processor is further configured to enable the ignition system based on the biometric input from the person and the positional data from the receiver.

26. The vehicle of claim 22 wherein the vehicle further includes a GPS receiver configured to transmit positional data to the biometric processor, and wherein the biometric processor is further configured to enable the ignition system based on the biometric input from the person and the positional data from the GPS receiver.

27. A system for controlling access to a vehicle, the system comprising:
means for receiving biometric input from a person;
means for determining, based on the biometric input, if the person is authorized to access the vehicle;
means for receiving vehicle location information;
means for determining, based on the location information, if the vehicle is in an acceptable location to allow access to the vehicle; and
means for allowing the person to access the vehicle when, based on the biometric input, the person is authorized to access the vehicle, and when, based on the location information, the vehicle is in an acceptable location to allow access to the vehicle.

28. The system of claim 27 wherein the means for receiving vehicle location information include means for receiving information from a satellite.

29. The system of claim 27 wherein the means for allowing the person to access the vehicle include means for automatically unlocking the vehicle when, based on the biometric input, the person is authorized to access the vehicle, and when, based on the location information, the vehicle is in an acceptable location to unlock the vehicle.

30. The system of claim 27 wherein the vehicle is a truck, and wherein the means for allowing the person to access the vehicle include means for allowing the person to access a secure portion of the truck.
